(19) United States
(12) Patent Application Publication
(10) Pub. No.: US 2023/0278389 A1
(43) Pub. Date: Sep. 7, 2023

(54) OUTDOOR HEATING SYSTEM FOR MOTOR VEHICLE

(71) Applicant: Ford Global Technologies, LLC, Dearborn, MI (US)

(72) Inventors: Stuart C. Salter, White Lake, MI (US); Jeffrey Robert Seaman, Brownstown, MI (US); Brendan Diamond, Grosse Pointe, MI (US); Annette Lynn Huebner, Highland, MI (US); Ryan O'Gorman, Beverly Hills, MI (US)

(21) Appl. No.: 17/683,622

(22) Filed: Mar. 1, 2022

(51) Int. Cl. B60H 1/00; B60H 1/22; G01J 5/00; B60L 50/60; B60L 1/02; B60L 53/16; B60L 58/12

(52) U.S. Cl. CPC B60H 1/00264; B60H 1/2226; B60H 1/00821; B60H 1/00792; B60H 1/0073; G01J 5/0025; B60L 50/60; B60L 1/02; B60L 53/16; B60L 58/12; G01J 2005/0077

(57) ABSTRACT

In some aspects, the techniques described herein relate to an outdoor heating system for a motor vehicle, including: a heater electrically connected to a power source of the motor vehicle and to a controller of the motor vehicle, wherein the heater is at least partially outside the motor vehicle, and wherein the controller is configured to issue commands to the heater to selectively adjust an output level of the heater and to selectively adjust an orientation of the heater.

### TECHNICAL FIELD

This disclosure relates to an outdoor heating system for a motor vehicle, and a corresponding method.

### BACKGROUND

Social events, such as camping and tailgating activities, may be held on or around vehicles. During such events, attendees are often outdoors for extended periods of time.

### SUMMARY

In some aspects, the techniques described herein relate to an outdoor heating system for a motor vehicle, including: a heater electrically connected to a power source of the motor vehicle and to a controller of the motor vehicle, wherein the heater is at least partially outside the motor vehicle, and wherein the controller is configured to issue commands to the heater to selectively adjust an output level of the heater and to selectively adjust an orientation of the heater.

In some aspects, the techniques described herein relate to an outdoor heating system, wherein the motor vehicle is an electrified vehicle and the power source is a traction battery.

In some aspects, the techniques described herein relate to an outdoor heating system, wherein: the motor vehicle includes a charging port, and the heater is electrically connected to the power source and the controller via the charging port.

In some aspects, the techniques described herein relate to an outdoor heating system, wherein the controller is configured to reduce an output level of the heater when a state of charge of the traction battery reaches a first threshold.

In some aspects, the techniques described herein relate to an outdoor heating system, wherein the controller is configured to deactivate the heater when a state of charge of the traction battery reaches a second threshold below the first threshold.

In some aspects, the techniques described herein relate to an outdoor heating system, wherein the heater is an infrared heater.

In some aspects, the techniques described herein relate to an outdoor heating system, further including: a sensor configured to generate signals indicative of activity adjacent the motor vehicle, wherein the controller is configured to adjust one or both of the output level and the orientation of the heater based on the signals from the sensor.

In some aspects, the techniques described herein relate to an outdoor heating system, wherein the sensor is one of a plurality of sensors of the motor vehicle.

In some aspects, the techniques described herein relate to an outdoor heating system, wherein the controller is configured to interpret information from one of the plurality of sensors as a location of an authorized individual, and to command the heater to aim toward the location.

In some aspects, the techniques described herein relate to an outdoor heating system, wherein: another of the plurality of sensors is a thermal imaging sensor and the controller is configured to interpret information from the thermal imaging sensor as a temperature of a body of the authorized individual, and the controller is configured to adjust one or both of the output level and the orientation of the heater based on the temperature of the body of the authorized individual.

In some aspects, the techniques described herein relate to an outdoor heating system, wherein the controller is configured to interpret information from one of the plurality of sensors as a stature of the authorized individual and to adjust the output level of the heater based on the stature.

In some aspects, the techniques described herein relate to an outdoor heating system, wherein the controller is configured to deactivate the heater if there are no authorized users within a predefined distance of the heater.

In some aspects, the techniques described herein relate to an outdoor heating system, wherein the controller is configured to adjust the output level of the heater based on environmental conditions.

In some aspects, the techniques described herein relate to an outdoor heating system, wherein the controller is configured to adjust the output level of the heater based on an expected duration of an event.

In some aspects, the techniques described herein relate to an outdoor heating system, wherein the controller is configured to issue a message to a user to manually move the heater.

In some aspects, the techniques described herein relate to a method, including: adjusting an output level of a heater electrically connected to a motor vehicle in response to a command from a controller of the motor vehicle, wherein the heater is outside the motor vehicle; and adjusting an orientation of the heater in response to a command from the controller.

In some aspects, the techniques described herein relate to a method, further including: identifying an authorized individual adjacent the heater; and adjusting the orientation of the heater such that the heater is aimed toward the authorized individual.

In some aspects, the techniques described herein relate to a method, further including: determining a temperature of a body of the authorized individual; and adjusting the output level of the heater based on the determined body temperature.

In some aspects, the techniques described herein relate to a method, further including: deactivating the heater if there are authorized individuals of a stature less than a predefined size within a predetermined distance of the heater.

In some aspects, the techniques described herein relate to a method, wherein the motor vehicle is an electrified vehicle and the heater is powered by a traction battery of the motor vehicle, and further including: deactivating the heater to preserve a state of charge of the traction battery.

### BRIEF DESCRIPTION OF THE DRAWINGS

FIG. 1 is representative an example outdoor heating system, with a motor vehicle shown from a top view and a heater shown from a front view.

FIG. 2 is a view of a plug and a charging port.

FIG. 3 illustrates various individuals and objects relative to the example outdoor heating system.

FIG. 4 illustrates two individuals relative to the example outdoor heating system.

### DETAILED DESCRIPTION

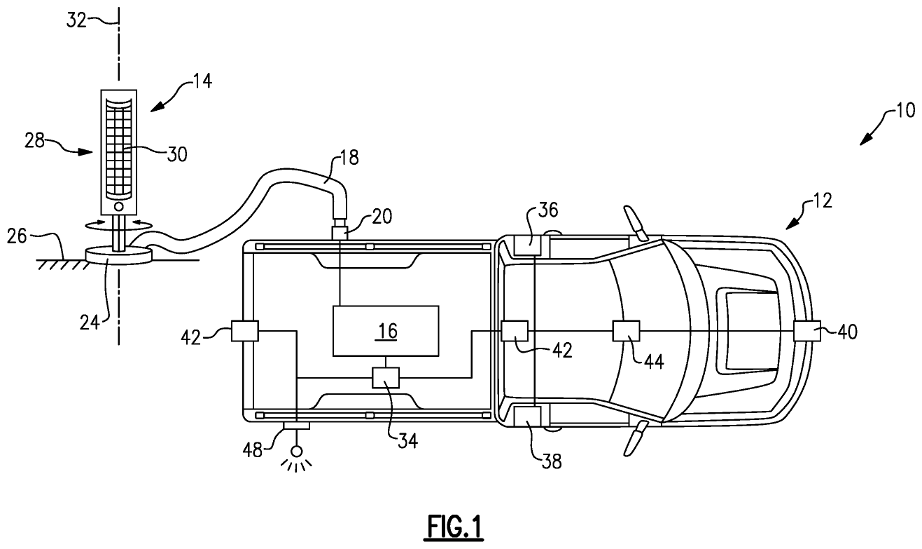

This disclosure relates to an outdoor heating system for a motor vehicle and a corresponding method. Referring to the drawings, FIG. 1 schematically illustrates an example outdoor heating system 10 according to this disclosure. The outdoor heating system 10 is particularly suited to providing convenient, portable heat during outdoor activities that take place on or around a vehicle, such as tailgating or camping activities, as examples. As another example, the outdoor heating system 10 may also be useful at worksites. Additional benefits will be appreciated from a review of the below description.

The outdoor heating system 10 generally includes a motor vehicle 12 (“vehicle 12”) and a heater 14. For ease of reference, the vehicle 12 is shown from a top perspective and the heater 14 is shown from a front perspective. The heater 14 is arranged outside the vehicle 12. The vehicle 12 is capable of controlling the heater 14, by adjusting an output level of the heater 14 and/or adjusting an orientation of the heater 14, as will be discussed below.

The vehicle 12 is a pickup truck in FIG. 1. This disclosure extends to other vehicle types, however. Further, in one example the vehicle 12 is an electrified vehicle, such as a battery electric vehicle (BEV) or plug-in hybrid vehicle (PHEV), in FIG. 1. The vehicle 12 includes a traction battery 16, which may be referred to as an electric vehicle battery or battery pack, configured to power electric motors that, in turn, turn wheels that drive the vehicle 12. The vehicle 12 is also configured to direct power from the traction battery 16 to the heater 14 such that the traction battery 16 provides a power source for the heater 14.

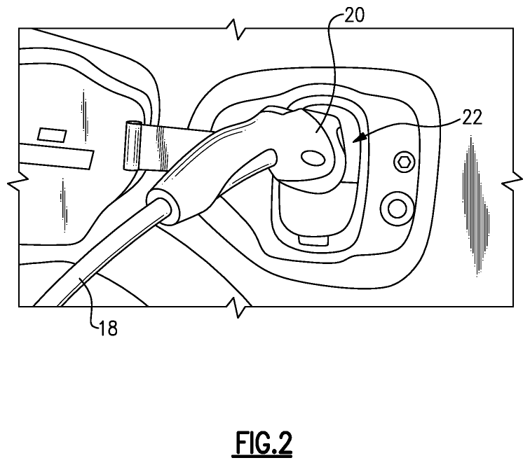

The heater 14 includes a cable 18 that has a plug 20 configured to couple to a charging port 22 (FIG. 2) of the vehicle 12. The vehicle 12 is configurable between one or more modes to permit bi-directional power flow relative to the traction battery 16. In one mode, power flows from the vehicle 12 to the heater 14 from the traction battery 16 via the cable 18, plug 20, and charging port 22. While the heater 14 includes the cable 18 and plug 20, the heater 14 could plug into another power outlet of the vehicle 12, such as a power outlet configured to receive a standard electrical plug. The charging port 22 may be a DC or AC charging port. While the heater 14 includes the cable 18 in FIG. 1, alternatively the vehicle 12 could include a cable that is configured to plug into the heater 14, or a separate cable could plug into both the vehicle 12 and the heater 14.

The heater 14 includes a stand 24 configured to rest on a ground surface 26, such as grass, concrete, or a cargo area of a pickup truck, and a heating section 28 including heating element 30, such as light bulbs. In an example, the heater 14 is an infrared heater and the heating element 30 includes infrared light bulbs. The heating section 28 is rotatable about a vertical axis 32 in this example. The vertical axis 32 is parallel to a length dimension of the heating section 28 and is perpendicular to the ground surface 26, in this example. The heater 14 includes one or more actuators responsive to commands from a controller 34 to rotate the heating section 28 about the vertical axis 32. While rotation of the heating section 28 about the vertical axis 32 is mentioned, this disclosure extends to other types of heaters which have an adjustable orientation, including heaters that are moveable vertically, horizontally, and rotationally.

The heater 14 is also responsive to commands from the controller 34 to adjust a heat output, or output level, of the heater 14. The heating element 30 may include zones that are selectively activatable independent of one another to produce different levels of heat, and the heater 14 may include fins or the like to direct, or vector, the heat output.

Further, while in FIG. 1 the heater 14 is completely outside the vehicle 12 and is shown on the ground surface 26, the heater 14 is be considered to be outside the vehicle 12 as long as at least a portion of the heater 14 is outside a passenger cabin of the vehicle 12. For example, the heater 14 could be positioned in a cargo bed of the vehicle 12 when the vehicle 12 is a pickup truck. The heater 14 could also be mounted to an outside of the vehicle 12.

The vehicle 12 includes the controller 34. The controller 34 could be part of an overall vehicle control module, such as a vehicle system controller (VSC), or could alternatively be a stand-alone controller separate from the VSC. Further, the controller 34 may be programmed with executable instructions for interfacing with and operating the various components of the vehicle 12. The controller 34 includes a processing unit and non-transitory memory for executing the various control strategies and modes of the vehicle 12 and outdoor heating system 10.

The vehicle 12 includes a plurality of sensors configured to generate signals indicative of activity adjacent the vehicle 12. The controller 34 is in communication with each of the sensors, is able to interpret signals from the sensors, and is able to selectively adjust an output level and/or orientation of the heater 14 based on those interpreted signals.

In an example, the vehicle 12 includes first, second, third, and fourth image sensors 36, 38, 40, 42 which may be cameras. The first and second image sensors 36 are mounted such that the first and second image sensor 36, 38 are able to capture still images or video of activity adjacent first and second opposed sides of the vehicle 12. The first and second image sensors 36, 38 may be integrated into a B-pillar applique of the vehicle 12. The third and fourth image sensors 40, 42 are mounted such that the third and fourth image sensors 40, 42 are able to capture still images or video of activity adjacent the front and rear of the vehicle 12, respectively.

A sensor 44 on top of the vehicle 12 is a light detection and ranging (LIDAR) sensor, in an example. The vehicle 12 also includes an additional sensor 46 adjacent a rear bumper of the vehicle 12. The sensor 46 may be an ultrasonic sensor.

While a particular arrangement of sensors is shown in FIG. 1, the vehicle 12 could include a different quantity or arrangement of sensors. Further, each of the sensors 36, 38, 40, 42, 44, 46 may be provided by one or more of image sensors, such as cameras, radio detecting and imaging (RADAR) sensors, LIDAR sensors, ultrasonic sensors, and wireless sensors systems utilizing Bluetooth® low energy (BLE) or Ultra Wide-Band (UWB) technology, as examples. One or more of the sensors 36, 38, 40, 42, 44, 46 may be part of a blind spot information system (BUIS) or another type of advanced driver-assistance system (ADAS). Further, one or more of the sensors 36, 38, 40, 42, 44, 46 may be thermal imaging sensors. The locations of the sensors 36, 38, 40, 42, 44, 46 are exemplary only. It should be understood that this disclosure extends to vehicles that have different exterior sensor systems.

The vehicle 12 can also include a transceiver 48 configured to receive signals from a key fob, a keypad on a door of the vehicle 12 (for example), a mobile device of a user (i.e., using the phone as a key, sometimes abbreviated PaaK), an radio-frequency identification (RFID) tag, or a button within the vehicle 12. The transceiver 48 may utilize BLE or UWB technology. The transceiver 48 may be considered a sensor. The transceiver 48 may also connect the controller 34 to the Internet. The sensors 36, 38, 40, 42, 44, 46 and transceiver 48 may be standard equipment on the vehicle 12 such that, other than the addition of the heater 14, this disclosure takes advantage of existing hardware of the vehicle 12.

In one aspect of this disclosure, the controller 34 is configured to adjust an output level of the heater 14 to efficiently deliver heat and to preserve the range of the traction battery 16. The output level of the heater 14 refers to the amount of heat produced by the heater 14, and may be measured in British Thermal Units (BTUs) or kilowatt hours, as examples. In this aspect of this disclosure, the controller 34 can use information, such as a distance between a current location and a home of a user or a charging location. The controller 34 can then determine an expected range, and an state of charge (SOC) of the traction battery 16 corresponding to that expected range, required to drive the vehicle 12 from the current location to the home or charging location. The controller 34 may add a buffer to the expected range, in one example. The locations can be determined using location-determining technology, such as a global positioning system (GPS).

In one example, the controller 34 operates the heater 14 until a first threshold state of charge (SOC) of the traction battery 16 is reached. When the first SOC threshold is reached, the controller 34 will command the heater 14 to operate at a lower output level until a second SOC threshold is reached. In this example, the second SOC threshold corresponds to the SOC, either with or without a buffer, required for a user to drive the vehicle 12 from the current location to the home or charging location. The first SOC is greater than the second SOC. Between the first and second SOCs, the heater 14 is operable but at a reduced level. At the second SOC, the heater 14 is deactivated to preserve the SOC of the traction battery 16. A message informing the user that the first and/or second SOCs have been reached may be sent. In another example, the controller 34 does not consider two thresholds, and instead deactivates the heater 14 to preserve a useful range for a return trip without first reducing the output level of the heater 14.

In another aspect of this disclosure, the controller 34 monitors the time it takes for the heater 14 to deplete the SOC of the traction battery 16, and commands adjustments to the heater 14 based on that information. For instance, if the traction battery 16 is being depleted faster than expected, such as if the traction battery 16 reaches the first SOC faster than expected, the controller 34 may command the heater 14 to output heat at a relatively low level or deactivate the heater 14 altogether.

The controller 34 may adjust the output level of the heater 14 based on various inputs. One example input includes environmental conditions, as indicated by a weather report and/or as determined by one or more sensors on the vehicle 12. The environmental conditions may include wind speed, ambient temperature, windchill, precipitation, etc. The weather report may be received by the transceiver 48, which may receive the report from a weather reporting service accessed using the Internet, for example. In an example, the controller 34 may increase the heat output by the heater 14 if the weather report indicates that the weather will be relatively cool.

In another aspect of this disclosure, the controller 34 determines whether the vehicle 12 is at an event, such as a college football game, and determines an approximate length of the event. The controller 34 may determine the vehicle 12 is at the event using location services and the Internet, as examples. Either alone or in combination with the weather report, the controller 34 may plan how to operate the heater 14 over the estimated event length. For instance, if a college football game is expected to last six hours and the weather report indicates the weather will be relatively cool for the first two hours of the event and then relatively warm, the controller 34 may send commands to the heater 14 to provide a relatively large heat output during the first two hours of the event, and then either taper off or completely deactivate the heater 14 as the weather warms. Alternatively, if the event is going to be relatively cool for the duration, the controller 34 may command the heater 14 to provide a consistent heat output over the duration of the event.

Another aspect of this disclosure relates to orienting the heater 14, and in particular relates to aiming the heater 14. In a specific aspect of this disclosure, the heater 14 is aimed only toward authorized individuals. The term authorized individuals refers to users of the outdoor heating system 10 that are authorized to use the outdoor heating system 10, such as owners or those designated by the owner(s) as being authorized. In an example, the controller 34 recognizes an authorized individual using facial recognition based on signals from one or more of the sensors 36, 38, 40, 42, 44, 46. While facial recognition is mentioned, the controller 34 could use other information to identify authorized users, such as their gait, apparel, etc. In this example, the owner of the vehicle 12 and other frequent users of the vehicle 12, such as family members of the owner, may have their faces saved by the controller 34 such that they can be recognized as authorized individuals. Alternatively or in addition, the controller 34 can recognize an authorized individual by recognizing a key fob or a mobile device of the individual based on signals from one or more of the sensors 36, 38, 40, 42, 44, 46 or the transceiver 48. The vehicle 12 may also recognize individuals in close proximity to an authorized individual as authorized individuals.

In addition to recognizing authorized individuals, the controller 34 is also able to interpret signals from one or more of the sensors 36, 38, 40, 42, 44, 46 to identify unauthorized individuals and/or various inanimate objects, such as adjacent vehicles, etc. Additionally, the controller 34 is configured to deactivate the heater 14 if there are no authorized users within a predefined distance of the heater 14. The controller 34 is also able to determine a location of the heater 14 relative to the vehicle 12 and various individuals and objects. The heater 14 may include a BLE emitter or an RFID tag to assist with determining the location of the heater 14. In general, the controller 34 is configured to command the heater 14 to aim toward authorized individuals and away from unauthorized individuals and other objects.

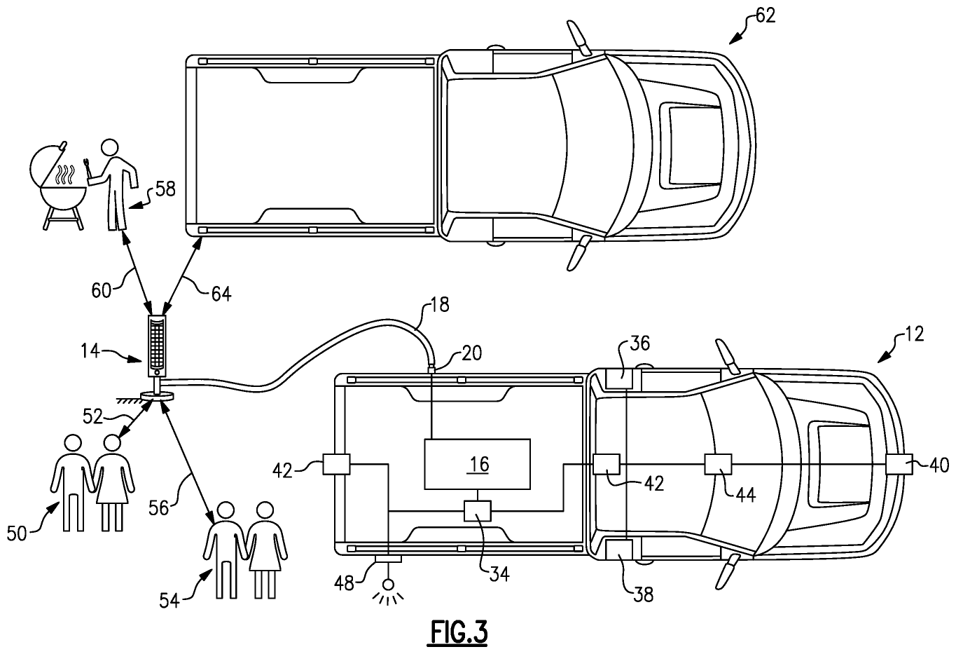

In an example, represented in FIG. 3, the heater 14 is placed on a ground surface adjacent the vehicle 12 and is plugged into the vehicle 12. The controller 34 recognizes a first group of authorized users 50 a first distance 52 from the heater 14 and a second group of authorized users 54 a second distance 56 from the heater 14. One member in each group of authorized users 50, 54 may be recognized using facial recognition, and the other member in each group 50, 54 may be considered an authorized user due to their close proximity to the member recognized using facial recognition. The controller 34 also recognizes an unauthorized user 58 a third distance 60 from the heater 14 and an object, namely another vehicle 62, a fourth distance 64 from the heater 14. In this example, the unauthorized user 58 and the other vehicle 62 are a sufficient distance away from the heater 14 to permit operation of the heater 14. If the unauthorized user 58 or other vehicle 62 were too close to the heater 14, such as being within a predefined threshold distance, the controller 34 may issue a message, either an audible message, a visual message (such as a flashing a light of the vehicle 12), and/or a prompt pushed to a screen of the vehicle 12 or a mobile device of the owner, instructing the authorized users 50, 54 to move the heater 14 further from the unauthorized user 58 or the other vehicle 62. Alternatively or in addition, the controller 34 will command the heater 14 to aim away from those unauthorized users or objects. Further, the controller 34 may issue a message if the heater 14 is too close to the vehicle 12. Alternatively or in addition, the controller 34 will command the heater 14 to aim away from the vehicle 12.

In the example of FIG. 3, the controller 34 commands the heater 14 to aim toward the first group of authorized users 50. The controller 34 may also issue a message instructing or suggesting that the second group of authorized users 54 to move closer to the heater 14. In another example, the controller 34 may command the heater 14 to oscillate between aiming at the first group of authorized users 50 and the second group of authorized users 54.

In one aspect of this disclosure, one or more of the sensors 36, 38, 40, 42, 44, 46 is a thermal imaging sensor and the controller 34 controller is configured to interpret information from the thermal imaging sensor as a temperature of a body of the authorized individuals, such as one or more of the members of the groups 50, 54. The controller 34 is configured to adjust the output and/or orientation of the heater 14 based on the detected body temperature of the authorized individuals. For instance, if the authorized individuals are relatively cold, the controller 34 will command the heater 14 to increase the heat output. If some of the authorized individuals are relatively cold and some are not, the controller 34 may command the heater 14 to aim at the relatively cold individuals. If the authorized individuals are relatively warm, the controller 34 may deactivate the heater 14 despite weather conditions, etc., indicating that the heater 14 should otherwise be activated. The controller 34 may use other information to determine if individuals are being heated appropriately, such as monitoring their behavior, facial expressions, etc. In one example, the controller 34 may determine an individual is relatively cold when the individual has their arms crossed, is pacing back-and-forth, is shaking, and/or is shivering.

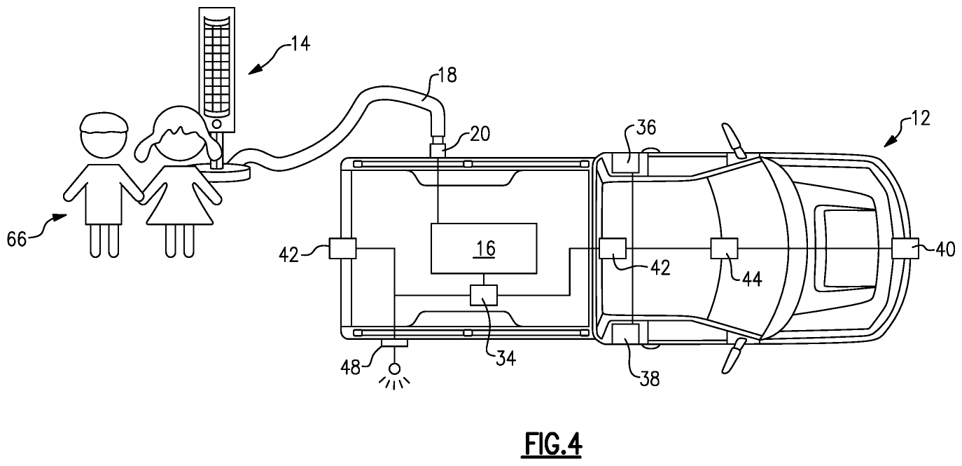

FIG. 4 is representative of another aspect of this disclosure in which the controller 34 is configured to interpret information from one or more of the sensors 36, 38, 40, 42, 44, 46 as a stature of an individual. In FIG. 4, there is a group of two authorized individuals 66. The controller 34 determines that the stature of one or both of the authorized individuals 66 is less than a predefined size, such as a predefined height. The controller 34 also determines, in FIG. 4, that the authorized individuals 66 are within a predetermined threshold distance of the heater 14, and therefore commands the heater 14 to deactivate. The predetermined threshold distance may be greater than for individuals having a larger stature. The controller 34 may also monitor a gait of an individual to determine whether the individual is walking in an unusual manner, and the controller 34 may deactivate the heater 14 if that individual comes within a predefined threshold distance of the heater 14, which may be a greater distance than for those individuals with a normal gait.

In a further aspect of this disclosure, the controller 34 is configured to command the heater 14 into an orientation conducive to roasting marshmallows. The orientation may include aiming the heater 14 such that the heater 14 directs heat in one direction. The orientation may include aiming the heater 14 upward, toward the sky, such that the heater 14 directs heat in a manner similar to a conventional firepit. In the marshmallow roasting mode, a heat output of the heater 14 may be relatively high.

In a further aspect of this disclosure, the outdoor heating system 10 is operable in a mode in which the controller 34 does not differentiate between authorized individuals and unauthorized individuals. A user of the vehicle 12 may be able to select this mode. In this mode, as long as an individual is within a predefined distance of the heater 14, the controller 34 will command the heater 14 to operate as discussed above, regardless of whether the individual is authorized or not. The outdoor heating system 10 can also be operated in a fully manual operation mode in which a user fully controls the operation of the heater 14. The outdoor heating system 10 can also be operated in a partially manual operation mode in which a user manually controls some aspects of the functionality of the heater 14 but relies on the controller 34 for various automated functions, such as those discussed above.

It should be understood that terms such as “about,” “substantially,” and “generally” are not intended to be boundaryless terms, and should be interpreted consistent with the way one skilled in the art would interpret those terms. Further, directional terms such as “forward,” “rearward,” “upward,” “downward,” “vertical,” “horizontal,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An outdoor heating system for a motor vehicle, comprising:
a heater electrically connected to a power source of the motor vehicle and to a controller of the motor vehicle, wherein the heater is at least partially outside the motor vehicle, and wherein the controller is configured to issue commands to the heater to selectively adjust an output level of the heater and to selectively adjust an orientation of the heater.

2. The outdoor heating system as recited in claim 1, wherein the motor vehicle is an electrified vehicle and the power source is a traction battery.

3. The outdoor heating system as recited in claim 2, wherein:
the motor vehicle includes a charging port, and
the heater is electrically connected to the power source and the controller via the charging port.

4. The outdoor heating system as recited in claim 2, wherein the controller is configured to reduce an output level of the heater when a state of charge of the traction battery reaches a first threshold.

5. The outdoor heating system as recited in claim 4, wherein the controller is configured to deactivate the heater when a state of charge of the traction battery reaches a second threshold below the first threshold.

6. The outdoor heating system as recited in claim 1, wherein the heater is an infrared heater.

7. The outdoor heating system as recited in claim 1, further comprising:
a sensor configured to generate signals indicative of activity adjacent the motor vehicle, wherein the controller is configured to adjust one or both of the output level and the orientation of the heater based on the signals from the sensor.

8. The outdoor heating system as recited in claim 7, wherein the sensor is one of a plurality of sensors of the motor vehicle.

9. The outdoor heating system as recited in claim 8, wherein the controller is configured to interpret information from one of the plurality of sensors as a location of an authorized individual, and to command the heater to aim toward the location.

10. The outdoor heating system as recited in claim 9, wherein:
another of the plurality of sensors is a thermal imaging sensor and the controller is configured to interpret information from the thermal imaging sensor as a temperature of a body of the authorized individual, and
the controller is configured to adjust one or both of the output level and the orientation of the heater based on the temperature of the body of the authorized individual.

11. The outdoor heating system as recited in claim 9, wherein the controller is configured to interpret information from one of the plurality of sensors as a stature of the authorized individual and to adjust the output level of the heater based on the stature.

12. The outdoor heating system as recited in claim 9, wherein the controller is configured to deactivate the heater if there are no authorized users within a predefined distance of the heater.

13. The outdoor heating system as recited in claim 1, wherein the controller is configured to adjust the output level of the heater based on environmental conditions.

14. The outdoor heating system as recited in claim 1, wherein the controller is configured to adjust the output level of the heater based on an expected duration of an event.

15. The outdoor heating system as recited in claim 1, wherein the controller is configured to issue a message to a user to manually move the heater.

16. A method, comprising:
adjusting an output level of a heater electrically connected to a motor vehicle in response to a command from a controller of the motor vehicle, wherein the heater is outside the motor vehicle; and
adjusting an orientation of the heater in response to a command from the controller.

17. The method as recited in claim 16, further comprising:
identifying an authorized individual adjacent the heater; and
adjusting the orientation of the heater such that the heater is aimed toward the authorized individual.

18. The method as recited in claim 17, further comprising:
determining a temperature of a body of the authorized individual; and
adjusting the output level of the heater based on the determined body temperature.

19. The method as recited in claim 16, further comprising:
deactivating the heater if there are authorized individuals of a stature less than a predefined size within a predetermined distance of the heater.

20. The method as recited in claim 16, wherein the motor vehicle is an electrified vehicle and the heater is powered by a traction battery of the motor vehicle, and further comprising:
deactivating the heater to preserve a state of charge of the traction battery.
